(19) United States
(12) Patent Application Publication
(10) Pub. No.: US 2014/0373928 A1
(43) Pub. Date: Dec. 25, 2014

(54) Pressure Balanced Hydraulic Device And Method

(71) Applicant: SPX Corporation, Charlotte, NC (US)

(72) Inventors: Michael Landrum, Rockford, IL (US); Dwight Booth, Milton, WI (US); Kevin Sintkowski, Rockford, IL (US)

(21) Appl. No.: 14/313,541

(22) Filed: Jun. 24, 2014

Related U.S. Application Data
(60) Provisional application No. 61/838,602, filed on Jun. 24, 2013.

(51) Int. Cl. F15B 13/02; F15B 21/00; F15B 1/26

(52) U.S. Cl. CPC F15B 13/026; F15B 1/26; F15B 21/001; F15B 2211/455
USPC 137/15.01; 137/565.11

(57) ABSTRACT

A hydraulic device includes a hydraulic pump, valve stack, interface tube, and upper and lower seals. The valve stack has a pressure balanced connecting with an interface tube receiving bore. The interface tube conveys a hydraulic fluid from the hydraulic pump to the valve stack and has an axial bore open at a first end and closed at a second end with an outlet proximal to the second end. The upper seal seals the interface tube in the interface tube receiving bore and is disposed annularly about the interface tube between the outlet and the second end. The lower seal seals the interface tube in the interface tube receiving bore and is disposed annularly about the interface tube proximal to the outlet and between the outlet and the first end. The upper seal and the lower seal balance a pressure of the hydraulic fluid from the outlet.

### CROSS REFERENCE TO RELATED APPLICATIONS

This application is a Non-provisional Patent Application and claims priority to U.S. Provisional Application Ser. No. 61/838,602, filed on Jun. 24, 2013, titled “PRESSURE BALANCED HYDRAULIC DEVICE AND METHOD”, the disclosure of which is incorporated herein by reference in its entirety.

### FIELD OF THE INVENTION

The present invention generally relates to a hydraulic device. More particularly, the present invention pertains to a pressure balanced hydraulic device and method of pressure balancing the hydraulic device.

### BACKGROUND OF THE INVENTION

Hydraulic systems often convey hydraulic fluid at relatively high pressure from one component to another in the hydraulic system. For example, it is common to convey hydraulic fluid from a pump to a valve stack. Due to the relatively high pressures of the hydraulic fluid, these components typically experience a great deal of force urging them apart. To keep the components together, the hydraulic systems typically include robust fasteners and support brackets. Unfortunately, these connections are heavy and utilize a great deal of raw materials which decreases the portability of the hydraulic system while increasing the cost.

Accordingly, it is desirable to provide a device and method of making the device that is capable of overcoming the disadvantages described herein at least to some extent.

### SUMMARY OF THE INVENTION

The foregoing needs are met, at least to a great extent, by the present invention, wherein in one respect a device and method of making the device is provided that in some embodiments pressure balances a hydraulic system.

An embodiment of the present invention pertains to a hydraulic device. The hydraulic device includes a hydraulic pump, a valve stack, an interface tube, and an upper and lower seal. The valve stack has a pressure balanced connecting having an interface tube receiving bore. The interface tube is to convey a hydraulic fluid from the hydraulic pump to the valve stack. The interface tube has an axial bore open at a first end and closed at a second end with an outlet proximal to the second end. The upper seal is to seal the interface tube in the interface tube receiving bore. The upper seal is disposed annularly about the interface tube between the outlet and the second end. The lower seal is to seal the interface tube in the interface tube receiving bore. The lower seal is disposed annularly about the interface tube proximal to the outlet and between the outlet and the first end. The upper seal and the lower seal are configured to balance a pressure of the hydraulic fluid from the outlet.

Another embodiment of the present invention relates to a method of making a hydraulic device. In this method, an interface tube receiving bore is disposed in a valve stack and an interface tube is disposed on a hydraulic pump. The interface tube has an axial bore open at a first end and closed at a second end with an outlet proximal to the second end. A pressure balanced connection is generated by inserting the interface tube in the interface receiving bore. The interface tube includes an upper and a lower seal. The upper seal is to seal the interface tube in the interface tube receiving bore. The upper seal is disposed annularly about the interface tube between the outlet and the second end. The lower seal is to seal the interface tube in the interface tube receiving bore. The lower seal is disposed annularly about the interface tube proximal to the outlet and between the outlet and the first end. The upper seal and the lower seal are configured to balance a pressure of the hydraulic fluid from the outlet.

Yet another embodiment of the present invention pertains to a method of reducing a weight of a hydraulic device. In this method, an interface tube receiving bore is disposed in a valve stack and an interface tube is disposed on a hydraulic pump. The interface tube has an axial bore open at a first end and closed at a second end with an outlet proximal to the second end. A pressure balanced connection is generated by inserting the interface tube in the interface receiving bore. The pressure balanced connection reduces forces urging the valve stack away from the hydraulic pump. The interface tube includes an upper and a lower seal. The upper seal is to seal the interface tube in the interface tube receiving bore. The upper seal is disposed annularly about the interface tube between the outlet and the second end. The lower seal is to seal the interface tube in the interface tube receiving bore. The lower seal is disposed annularly about the interface tube proximal to the outlet and between the outlet and the first end. The upper seal and the lower seal are configured to balance a pressure of the hydraulic fluid from the outlet. The weight of the hydraulic device is reduced by reducing a value stack bracket weight in response to the reduced forces.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view of a hydraulic system in accordance with the disclosure.

FIG. 2 is a more detailed cross-sectional view of the hydraulic system shown in FIG. 1.

FIG. 3 is a more detailed cross-sectional view of another embodiment of the hydraulic system shown in FIG. 1.

FIG. 4 is another more detailed cross-sectional view of the hydraulic system shown in FIG. 1.

### DETAILED DESCRIPTION

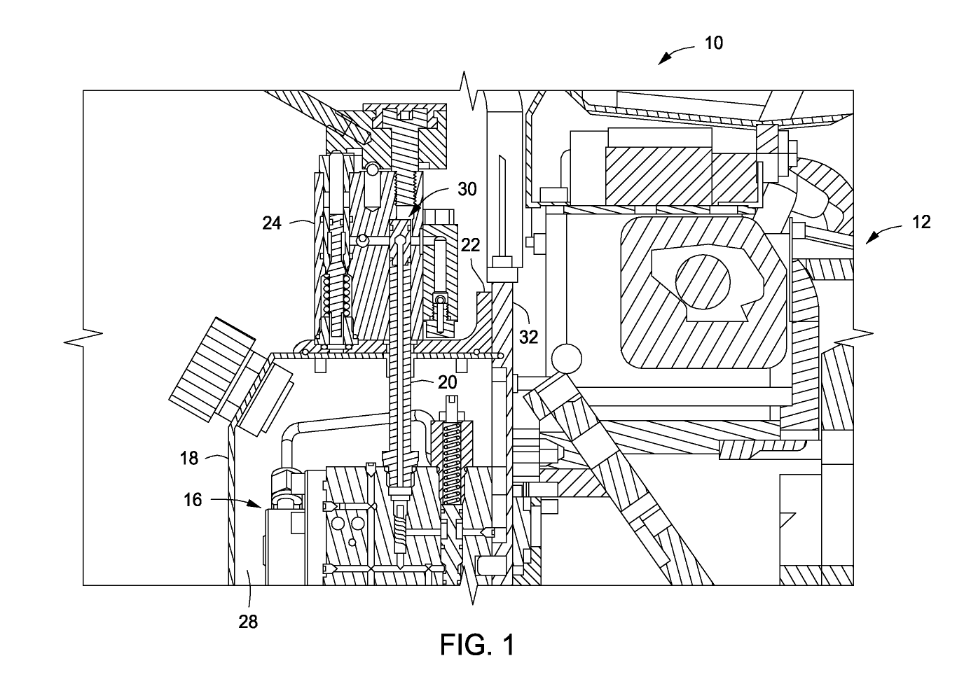

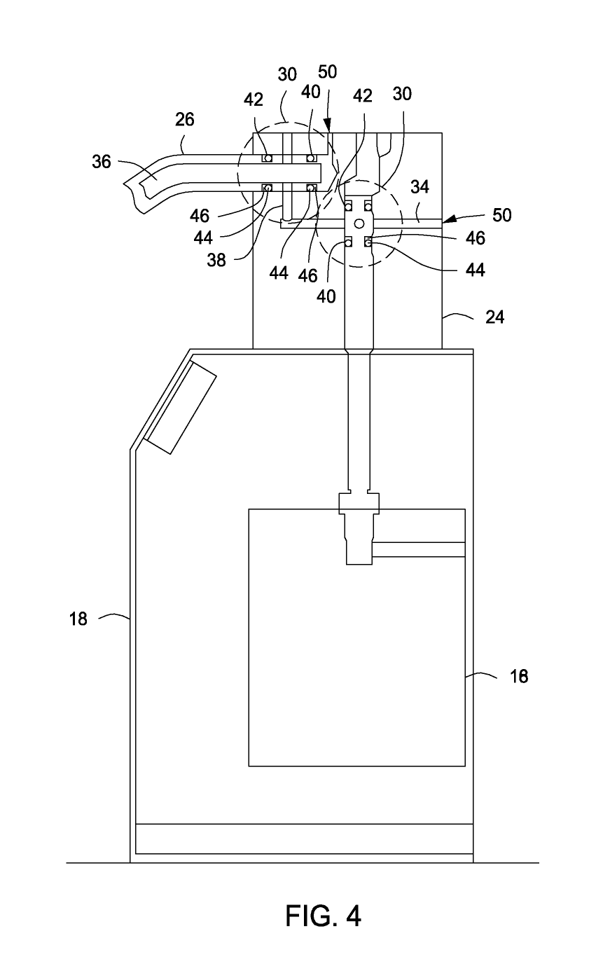

An embodiment of the invention will now be described with reference to the drawing figures, in which like reference numerals refer to like parts throughout. FIG. 1 is a cross-sectional view of a hydraulic system 10 in accordance with the disclosure. As shown in FIG. 1, the hydraulic system 10 includes a motor 12, hydraulic pump 16, hydraulic fluid reservoir 18, interface tube 20, valve stack bracket 22, and valve stack 24. In addition, the hydraulic system 10 includes a hydraulic hose 26 shown in FIG. 4. Returning to FIG. 1, in general, power or torque generated by the motor 12 is utilized by the hydraulic pump 16 to urge a flow of a hydraulic fluid 28.

The motor 12 includes any suitable engine, motor, actuator, or the like. More particularly, the motor 12 includes any suitable electric motor, pneumatic motor, and combustion engine. Engines are typically rated by the power output (e.g., duty) and the specific engine or actuator selected may depend on such factors as, for example, the particular task to be performed, the availability of electricity, the availability of fuel, the working environment, and the like. Similarly, the hydraulic pump 16 may include any suitable units and are typically selected to have a duty rating corresponding to that of the motor 12. By selecting components having the same or similar duty rating, the hydraulic system 10 may be optimized.

The hydraulic fluid reservoir 18 is configured to retain a sufficient supply of the hydraulic fluid 28. In general, the hydraulic fluid reservoir 18 is not subject to an elevated pressure. Accordingly, the hydraulic fluid reservoir 18 may be made from relatively light and/or thin materials such as, for example, aluminum, magnesium, polymers, and the like. As shown in FIG. 1, the hydraulic pump 16 may be disposed within the hydraulic fluid reservoir 18 in order to bathe the hydraulic fluid reservoir 18 in the hydraulic fluid 28. In this manner, the hydraulic pump 16 may be supplied with the hydraulic fluid 28, the hydraulic pump 16 may be lubricated by the hydraulic fluid 28, heat generated by the hydraulic pump 16 may be removed by the hydraulic fluid 28, and the like. As such, the hydraulic fluid reservoir 18 may include a material with relatively high thermal conductivity such as, for example, aluminum or other metal.

The interface tube 20 is configured to convey pressurized hydraulic fluid from the hydraulic pump 16 to the valve stack 24. As described herein, the interface tube 20 may include a pressure balanced connection 30 at one or both ends. For example, the interface tube 20 includes a first end disposed at the hydraulic pump 16 and a second end disposed at the valve stack 24. According to this or other embodiments, one or both of the first and second ends may include the pressure balanced connection 30. For the purposes of this disclosure, the pressure balanced connection 30 includes any suitable connection or mated conduit balance or distribute forces acting on the connected components such that pressure-generated forces acting to urge the components apart are balanced, at least to a large extent, by pressure-generated forces acting to urge the components together.

The valve stack bracket 22, is fastened to a frame 32 and configured to provide a support member for the valve stack 24. In conventional hydraulic systems, the valve stack bracket is made relatively thick and strong to prevent the pressure of the hydraulic fluid from tearing the valve stack off the hydraulic system. It is an advantage of the hydraulic system 10 that the pressure balanced connection 30 reduces or eliminates the forces urging the valve stack 24 off the hydraulic system 10. As such, the valve stack bracket 22 may be optionally removed or made thinner, lighter, less expensively, and the like as compared to conventional valve stack brackets. If the valve stack bracket 22 is removed, the valve stack 24 may be affixed directly to the hydraulic fluid reservoir 18, for example.

The valve stack 24 is configured to provide a connection for the hydraulic hose 26 (shown in FIG. 4) and one or more valves to control the flow of the hydraulic fluid 28. In addition, the valve stack 24 may include a recirculation flow path, an overpressure relief valve, and the like. The recirculation flow path is configured to reduce wear on the motor 12 and hydraulic pump 16 by allowing the hydraulic fluid 28 to return to the hydraulic fluid reservoir 18 if insufficient flow is conveyed to the hydraulic hose 26.

The hydraulic hose 26 is configured to convey the hydraulic fluid 28 to and/or from a hydraulically driven device (not shown). Typically, there are two of the hydraulic hoses 26 with one delivering the pressurized hydraulic fluid 28 to the hydraulically driven device and one to return the hydraulic fluid 28 to the valve stack 24 and, from there, back to the hydraulic fluid reservoir 18.

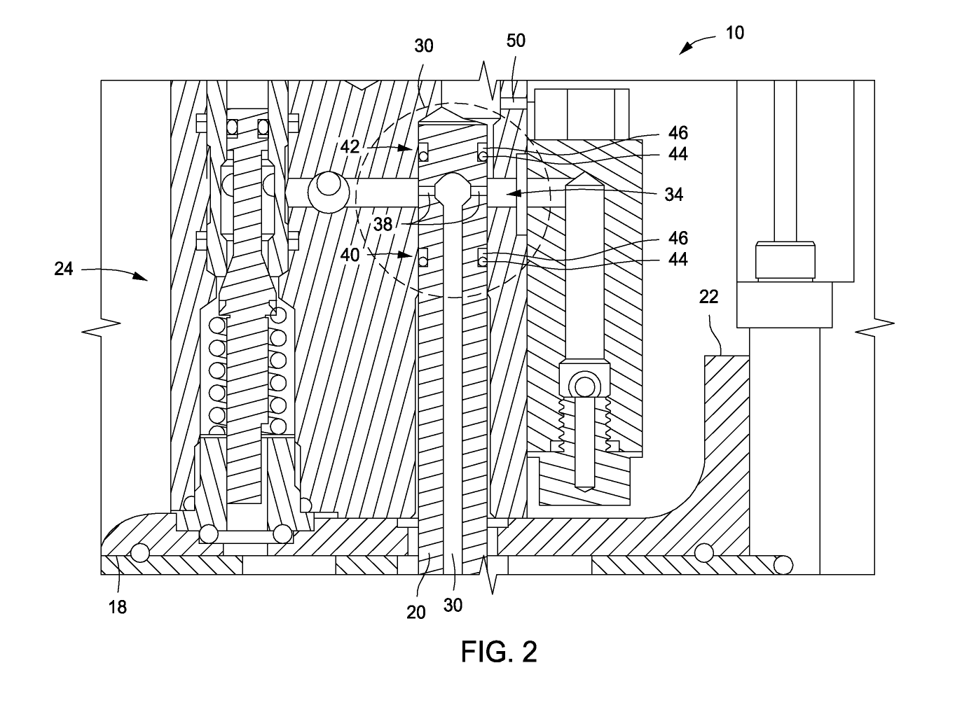

FIG. 2 is a more detailed cross-sectional view of the hydraulic system 10 shown in FIG. 1. As shown in FIG. 2, the pressure balanced connection 30 is disposed at the junction of the interface tube 20 and a cross communication port 34. In the particular example shown, the interface tube 20 includes a blind passage 36, outlets 38, lower seal 40, and upper seal 42. In use, the hydraulic fluid 28 is urged up the blind passage 36 and out the outlets 38. The lower seal 40 and the upper seal 42 are configured to reduce or prevent leakage of the hydraulic fluid 28 at the interface of the interface tube 20 and the valve stack 24. By disposing the lower seal 40 below the outlets 38 and the upper seal 42 above the outlets 38, the hydraulic fluid 28 that does enter the interface exerts an equal and opposite force against the lower seal 40 and the upper seal 42. As such, the connection of the outlets 38 with the cross communication port 34 is pressure balanced. The lower seal 40 and the upper seal 42 may include any suitable sealing material or method. For example, the lower seal 40 and/or the upper seal 42 may include elastomeric, polymer, or metallic gaskets, O-rings, or the like. In a particular example, the lower seal 40 and the upper seal 42 include an elastomeric O-ring 44 seated in an annular groove 46.

Also shown in FIG. 2, the pressure balanced connection 30 optionally includes a weep hole 50. If included, the weep hole 50 is configured to provide an outlet for leakage of the hydraulic fluid 28 past the upper seal 42. Release of the hydraulic fluid 28 from the weep hole 50 serves the dual purpose of indicating a failure of the upper seal 42 and reducing or preventing the leakage of the hydraulic fluid 28 from unbalancing the balanced connection 30.

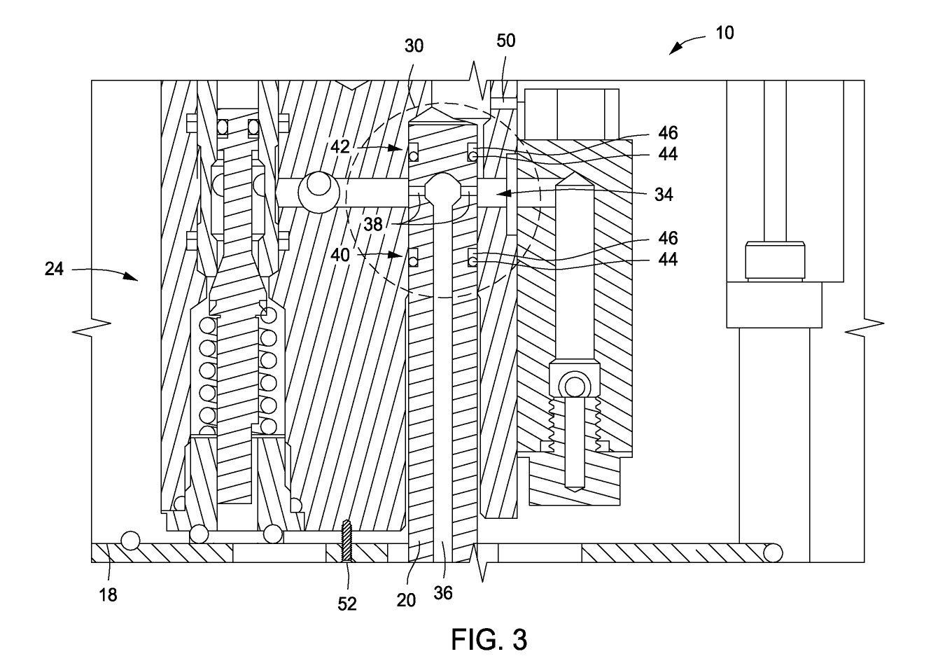

FIG. 3 is a more detailed cross-sectional view of another embodiment of the hydraulic system 10 shown in FIG. 1. The embodiment of FIG. 3 is similar to the embodiment of FIG. 2 and thus, for the sake of brevity, those elements already described will not be described again. As shown in FIG. 3, the hydraulic system 10 does not include the valve stack bracket 22. For example, rather than the valve stack bracket 22 shown in FIGS. 1 and 2, a fastener 52 may be used to secure the valve stack 24 to the hydraulic fluid reserve 18. It is an advantage of this and other embodiments of the hydraulic system 10 that the balanced connection 30 enables the use of a relatively small fastener into a relatively light duty element such as the hydraulic fluid reserve 18. As a result, a relatively heavy and/or expensive element such as the valve stack bracket 22 shown in FIGS. 1 and 2 may be omitted and the hydraulic system 10 may be manufactured more economically and/or may be more portable.

FIG. 4 is another more detailed cross-sectional view of the hydraulic hose 26 shown in FIG. 1. As shown in FIG. 4, the hydraulic hose 26 may optionally include the pressure balanced connection 30. If included, the hydraulic hose 26 may include the blind passage 36 and the outlets 38. The lower seal 40 and the upper seal 42 may be disposed on the hydraulic hose 26 or in a bore 60 configured to receive the hydraulic hose 26.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hydraulic device comprising:
a hydraulic pump;
a valve stack having a pressure balanced connecting having an interface tube receiving bore;
an interface tube to convey a hydraulic fluid from the hydraulic pump to the valve stack, the interface tube having an axial bore open at a first end and closed at a second end with an outlet proximal to the second end;
an upper seal to seal the interface tube in the interface tube receiving bore, the upper seal being disposed annularly about the interface tube between the outlet and the second end; and
a lower seal to seal the interface tube in the interface tube receiving bore, the lower seal being disposed annularly about the interface tube proximal to the outlet and between the outlet and the first end, wherein the upper seal and the lower seal are configured to balance a pressure of the hydraulic fluid from the outlet.

2. The hydraulic device according to claim 1, further comprising:
a hydraulic hose configured to mate with the valve stack, the hydraulic hose having:
a hose connector disposed at an end of the hydraulic hose, the hose connector being configured to mate with a connector receiver disposed on the valve stack;
a connector port disposed proximal to an end of the hose connector and perpendicular to an axial channel in the hose connector;
an upper hose seal to seal the hose connector in the connector receiver, the upper hose seal being disposed annularly about hose connector between the outlet and the second end; and
a lower hose seal to seal the hose connector in the connector receiver, the lower hose seal being disposed annularly about the hose connector proximal to the outlet and between the outlet and the first end, wherein the upper hose seal and the lower hose seal are configured to balance a pressure of the hydraulic fluid from the outlet.

3. The hydraulic device according to claim 1, further comprising:
a weep hole disposed in the interface receiving bore above the upper seal.

4. The hydraulic device according to claim 1, further comprising:
a reservoir to supply the hydraulic pump with the hydraulic fluid.

5. The hydraulic device according to claim 1, further comprising:
a fastener to affix the valve stack relative to the hydraulic pump.

6. The hydraulic device according to claim 5, further comprising:
a bracket affixed the valve stack.

7. The hydraulic device according to claim 1, further comprising:
a cross communication port disposed in cooperative alignment with the outlet.

8. A method of making a hydraulic device comprising the steps of:
disposing an interface tube receiving bore in a valve stack;
disposing an interface tube on a hydraulic pump, the interface tube having an axial bore open at a first end and closed at a second end with an outlet proximal to the second end; and
generating a pressure balanced connection by inserting the interface tube in the interface receiving bore, wherein the interface tube includes:
an upper seal to seal the interface tube in the interface tube receiving bore, the upper seal being disposed annularly about the interface tube between the outlet and the second end; and
a lower seal to seal the interface tube in the interface tube receiving bore, the lower seal being disposed annularly about the interface tube proximal to the outlet and between the outlet and the first end, wherein the upper seal and the lower seal are configured to balance a pressure of the hydraulic fluid from the outlet.

9. The method according to claim 8, further comprising the step of:
mating a hydraulic hose configured to the valve stack, the hydraulic hose having:
a hose connector disposed at an end of the hydraulic hose, the hose connector being configured to mate with a connector receiver disposed on the valve stack;
a connector port disposed proximal to an end of the hose connector and perpendicular to an axial channel in the hose connector;
an upper hose seal to seal the hose connector in the connector receiver, the upper hose seal being disposed annularly about hose connector between the outlet and the second end; and
a lower hose seal to seal the hose connector in the connector receiver, the lower hose seal being disposed annularly about the hose connector proximal to the outlet and between the outlet and the first end, wherein the upper hose seal and the lower hose seal are configured to balance a pressure of the hydraulic fluid from the outlet.

10. The method according to claim 8, further comprising the steps of:
disposing a weep hole in the interface receiving bore above the upper seal.

11. The method according to claim 8, further comprising the steps of:
supplying the hydraulic fluid to the hydraulic pump with a reservoir.

12. The method according to claim 8, further comprising the steps of:
affixing the valve stack relative to the hydraulic pump.

13. The method according to claim 12, further comprising the steps of:
affixing a bracket to the valve stack.

14. The method according to claim 8, further comprising the steps of:
disposing a cross communication port in cooperative alignment with the outlet.

15. A method of reducing a weight of a hydraulic device comprising the steps of:
disposing an interface tube receiving bore in a valve stack;
disposing an interface tube on a hydraulic pump, the interface tube having an axial bore open at a first end and closed at a second end with an outlet proximal to the second end;
generating a pressure balanced connection by inserting the interface tube in the interface receiving bore, wherein the pressure balanced connection reduces forces urging the valve stack away from the hydraulic pump, wherein the interface tube includes:
an upper seal to seal the interface tube in the interface tube receiving bore, the upper seal being disposed annularly about the interface tube between the outlet and the second end; and
a lower seal to seal the interface tube in the interface tube receiving bore, the lower seal being disposed annularly about the interface tube proximal to the outlet and between the outlet and the first end, wherein the upper seal and the lower seal are configured to balance a pressure of the hydraulic fluid from the outlet; and
reducing the weight of the hydraulic device by reducing a value stack bracket weight in response to the reduced forces.

16. The method according to claim 15, further comprising the step of:
mating a hydraulic hose configured to the valve stack, the hydraulic hose having:
a hose connector disposed at an end of the hydraulic hose, the hose connector being configured to mate with a connector receiver disposed on the valve stack;
a connector port disposed proximal to an end of the hose connector and perpendicular to an axial channel in the hose connector;
an upper hose seal to seal the hose connector in the connector receiver, the upper hose seal being disposed annularly about hose connector between the outlet and the second end; and
a lower hose seal to seal the hose connector in the connector receiver, the lower hose seal being disposed annularly about the hose connector proximal to the outlet and between the outlet and the first end, wherein the upper hose seal and the lower hose seal are configured to balance a pressure of the hydraulic fluid from the outlet.

17. The method according to claim 15, further comprising the steps of:
disposing a weep hole in the interface receiving bore above the upper seal.

18. The method according to claim 15, further comprising the steps of:
disposing a cross communication port in cooperative alignment with the outlet.

19. The method according to claim 15, further comprising the steps of:
affixing the valve stack relative to the hydraulic pump.

20. The method according to claim 19, further comprising the steps of:
affixing a bracket to the valve stack.
